(19) United States
(12) Patent Application Publication
(10) Pub. No.: US 2026/0011953 A1
(43) Pub. Date: Jan. 8, 2026

(54) ELECTRICAL CONNECTOR

(71) Applicant: Xiaoping Zhu, Dongguan (CN)

(72) Inventor: Xiaoping Zhu, Dongguan (CN)

(21) Appl. No.: 19/324,117

(22) Filed: Sep. 10, 2025

(30) Foreign Application Priority Data
Sep. 1, 2025 (CN) 202511240853.7

(51) Int. Cl. H01R 13/621; H01R 24/30; H01R 43/26; H01R 105/00

(52) U.S. Cl. CPC H01R 13/6215; H01R 24/30; H01R 43/26; H01R 2105/00

(57) ABSTRACT

An electrical connector is provided, including: a shell, an electrical connection portion, an actuator, a first gear, and a shaft lever. The electrical connection portion is arranged on the shell. The actuator is rotatably connected to the shell. The actuator is in transmission connection to the first gear to cause the first gear to rotate. The shaft lever is provided with a second gear, a first threaded region, and a second threaded region. The second gear meshes with the first gear. The first threaded region has the same thread direction as the second threaded region, and is in threaded connection with the shell. The second threaded region is configured to be screwed into a hole of the adapter connector to be fastened with an inner wall of the adapter connector. The electrical connector can be fastened with the adapter connector in a more stable locking manner.

### TECHNICAL FIELD

The present disclosure relates to the technical field of connectors, and in particular, to an electrical connector capable of being stably locked to an adapter connector.

### BACKGROUND

Electrical connectors can implement electrical connection and are commonly applied to electrical equipment. In order to prevent unlocking after an electrical connector is electrically connected to an adapter connector, a locking structure will be arranged on the electrical connector. The existing locking structure is usually a fastener. The fastener is fastened to the adapter connector to implement stable connection between the electrical connector and the adapter connector. This locking structure has a weak locking force and is relatively easily unlocked.

### SUMMARY

In view of this, in order to solve one of the technical problems in the related art to an extent, it is necessary to provide an electrical connector which can be fastened to an adapter connector in a more stable locking manner.

The electrical connector includes:
a shell, an electrical connection portion, an actuator, a first gear, and a shaft lever.

The electrical connection portion is arranged on the shell.

The actuator is rotatably connected to the shell.

The actuator is in transmission connection with the first gear to cause the first gear to rotate.

The shaft lever is provided with a second gear, a first threaded region, and a second threaded region. The second gear meshes with the first gear. The first threaded region has the same thread direction as the second threaded region, and is in threaded connection with the shell. The second threaded region is configured to be screwed into a hole of the adapter connector to be fastened with an inner wall of the adapter connector.

In a use process, the electrical connector is electrically connected to the adapter connector. The actuator is rotated to cause the first gear to rotate and drive the second gear to rotate, so that the shaft lever rotates. Through the threaded connection between the first threaded region and the shell, the shaft lever can move forwards while rotating. The second threaded region can be screwed into the hole of the adapter connector in the thread direction and is fastened to the inner wall of the adapter connector. The actuator is rotated anticlockwise to cause the second threaded region to be screwed out of the hole of the adapter connector in the thread direction, thus implementing unlocking.

### BRIEF DESCRIPTION OF THE DRAWINGS

FIG. 1 is a schematic structural diagram of a specific implementation of the present disclosure.

FIG. 2 is a schematic structural diagram of a cross section along line i-i of FIG. 1 and plugging into an adapter connector.

FIG. 3 is a schematic diagram of transmission structures such as an actuator, a first gear, and a shaft lever.

FIG. 4 is a schematic diagram of an internal structure of the electrical connector of FIG. 1 in an unlocked state.

FIG. 5 is a schematic diagram of an internal structure of the electrical connector of FIG. 1 in a locked state.

FIG. 6 is a front view of FIG. 1.

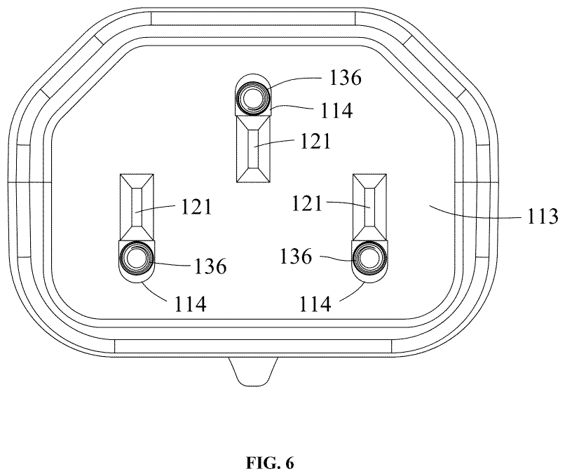

The present disclosure will be further described below according to specific implementations with reference to the above accompanying drawings.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the embodiments of the present disclosure without making creative efforts shall fall within the protection scope of the present disclosure. It can be understood that the accompanying drawings are only for reference and illustration purposes and are not intended to limit the present disclosure. The connection relationship shown in the accompanying drawings is only for the sake of clear description and does not limit a connection method.

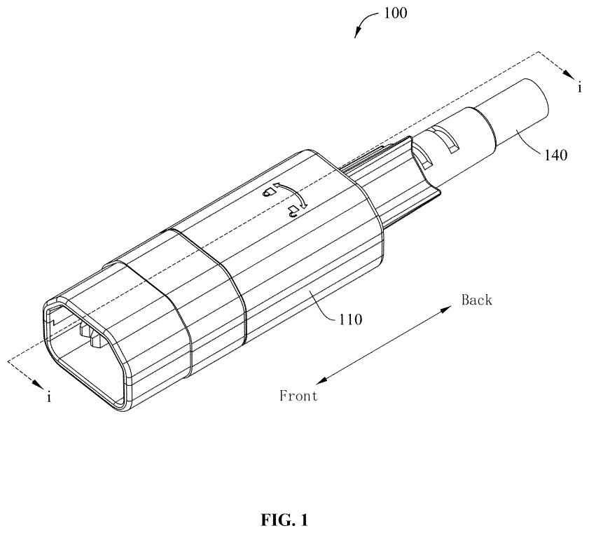

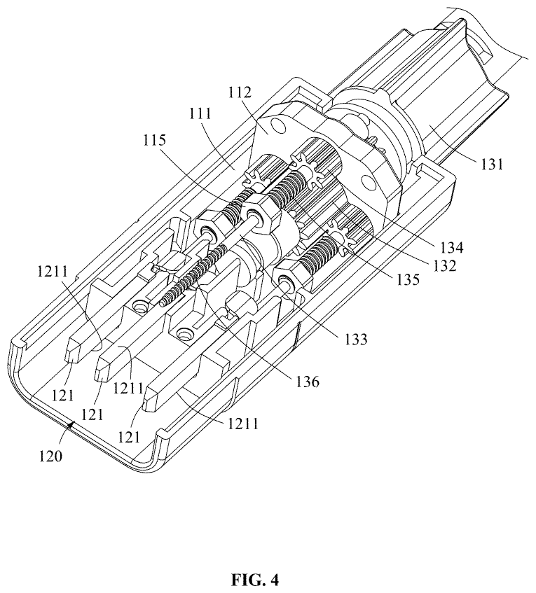

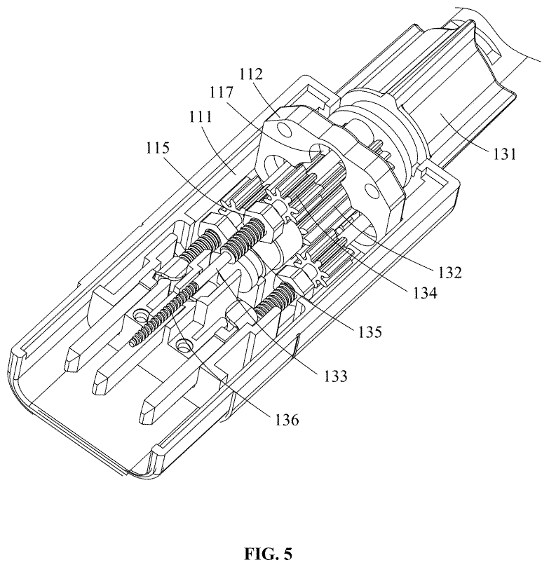

A specific implementation of the present disclosure provides an electrical connector 100. As shown in FIG. 1 to FIG. 5, the electrical connector 100 includes a shell 110 and an electrical connection portion 120 arranged on the shell 110. The electrical connection portion 120 is connected with a cable 140 inside the shell 110. The shell 110 includes an outer shell 111 and an inner shell 112.

In this specific implementation, the electrical connector 100 is a plug. The electrical connection portion 120 includes a pin 121. An adapter connector 10 is a socket. Further, the electrical connection portion 120 may include two pins 121 or three pins 121. One pin 121 is a neutral wire pin 121. One pin 121 is a live wire pin 121. One pin 121 is a ground wire pin 121.

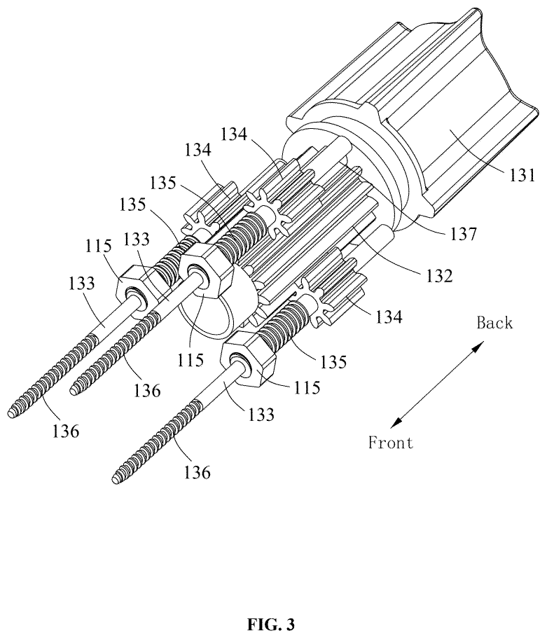

Specifically, as shown in FIG. 3 to FIG. 5, the electrical connector 100 includes an actuator 131, a first gear 132, and a shaft lever 133.

The first gear 132 is arranged inside the shell 110, and the actuator 131 is rotatably connected to the shell 110. The actuator 131 includes an operating portion arranged outside the shell 110. An inside of the actuator 131 is connected to the first gear 132. The user can operate the actuator 131 through the operating portion to cause the actuator 131 and the first gear 132 to rotate.

The shaft lever 133 is provided with a second gear 134, a first threaded region 135, and a second threaded region 136. The second gear 134 meshes with the first gear 132. When rotating, the first gear 132 can drive the second gear 134 to rotate and cause the shaft lever 133 to rotate. The first threaded region 135 is in threaded connection to the shell 110. Specifically, a nut 115 is arranged on the inner shell 112. The first threaded region 135 is in threaded connection to the nut 115. The second threaded region 136 is close to a front end of the shaft lever 133. The second threaded region 136 has the same thread direction as the first threaded region 135. The second threaded region 136 is configured to be screwed into a hole 11 of the adapter connector 10 to be fastened with an inner wall 12 of the adapter connector 10.

During use, the electrical connector 100 is electrically connected to the adapter connector 10 after being plugged into the adapter connector 10. The actuator 131 is rotated to cause the first gear 132 to rotate and drive the second gear 134 to rotate, thereby causing the shaft lever 133 to rotate. Based on the threaded connection between the first threaded region 135 and the shell 110, the shaft lever 133 can move forwards while rotating. The shaft lever 133 rotates forwards synchronously and implements forward pushing, and the second threaded region 136 can be screwed into the hole 11 of the adapter connector 10 in the thread direction. During screwing in, the second threaded region 136 can make the electrical connector 100 and the adapter connector 10 tend to approach each other. The second threaded region 136 can tightly grasp an inner wall 12 of the adapter connector 10 and be fastened, so that it is difficult to easily unlock the electrical connector 100 from the adapter connector 10. Anticlockwise rotation of the actuator 131 can cause the second threaded region 136 to rotate out of the hole 11 of the adapter connector 10 in the thread direction, and cause the electrical connector 100 and the adapter connector 10 to tend to be separated from each other, thereby implementing unlocking. The user can separate the electrical connector 100 from the adapter connector 10.

The second threaded region 136 is preferably a self-tapping cutting thread. In the process of being screwed into the hole 11, the self-tapping cutting thread can be gradually tightened on the inner wall 12 of the adapter connector 10 in a cutting and squeezing manner.

A via hole 114 is formed in a front wall 113 of the electrical connector 100. In an unlocked state, a front end of the shaft lever 133 retracts into the via hole 114. In a locking process, a front end portion of the shaft lever 133 can move forwards while rotating, to extend out of a front side of the front wall 113 from the via hole 114.

The hole 11 of the adapter connector 10 is designed for plugging of the pin 121 and is electrically connected to the adapter connector 10. The hole 11 can simultaneously accommodate the pin 121 and the second threaded region 136. The shaft lever 133 is arranged to be close to the pin 121, to cause the pin 121 and the second threaded region 136 to enter the hole 11 of the adapter connector 10 together, thus fastening the second threaded region 136 to two opposite inner walls 12 of the adapter connector 10. Therefore, the electrical connector 100 can be applied to a general-purpose adapter connector 10.

In this specific implementation, the electrical connector 100 includes a plurality of shaft levers 133. Three shaft levers 133 are shown. The plurality of shaft levers 133 are parallel to each other. One shaft lever 133 corresponds to a position of one plug 121. The plurality of shaft levers 133 are distributed in a circumferential direction of the first gear 132. Specifically, when there are more than two pins 121, one shaft lever 133 can be arranged at a position corresponding to two pins 121 or each pin 121. Each shaft lever 133 is provided with the second gear 134, the first threaded region 135, and the second threaded region 136. When the actuator 131 rotates, the first gear 132 can drive the plurality of shaft levers 133 to perform the above actions simultaneously, thus implementing multi-point locking and unlocking of the electrical connector 100 and the adapter connector 10.

An axis of each shaft lever 133 can be selected to be parallel to an extension direction of the pin 121.

When the second threaded region 136 is in a fastened state, the second threaded region 136 is located on one side of the pin 121. Specifically, when the second threaded region 136 is in the fastened state, the second threaded region 136 is located on a thin surface 1211 side of the pin 121 and can be clung to the thin surface 1211. A diameter of the second threaded region 136 can be equivalent to or smaller than the pin 121, so that the second threaded region 136 is fastened to the opposite inner walls 12 of the hole 11. A diameter of the second threaded region 136 is preferably within a size range of 1.2 mm to 1.7 mm.

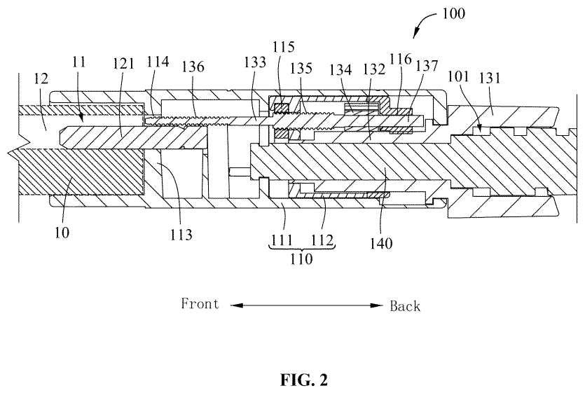

Continuing to refer to FIG. 2, the actuator 131 can be of an integral structure with the first gear 132. The actuator 131 and the first gear 132 have axially penetrating inner cavities 101. The cable 140 is threaded into the inner cavities 101 and extends out of the shell 110 from an outer end of the actuator 131. The actuator 131 and the first gear 132 are rotatable relative to the cable 140, and the actuator 131 and the first gear 132 do not interfere with the cable 140 during rotation. Therefore, there is no need to separately design a position to arrange the cable 140, which can save a space.

A sliding shaft portion 137 is arranged at a rear end of each shaft lever 133, and the shell 110 is provided with a sliding hole 116. The sliding hole 116 is specifically arranged on the inner shell 112. The sliding shaft portion 137 is slidably arranged inside the sliding hole 116. The shaft levers 133 are mounted on the inner shell 112 by relying on the nut 115 and the sliding hole 116, and move forwards and backwards in an axial direction.

The shell 110 has a stop surface 117. The stop surface 117 is specifically arranged on the inner shell 112. The stop surface 117 is located on a rear side of the second gear 134. After the shaft levers 133 move backwards to be unlocked, the stop surface 117 can prevent the second gear 134 from continuing to move backwards.

The above only describes the preferred embodiments of the present disclosure and is not intended to limit the present disclosure. Any modification, equivalent replacement, and improvement made within the spirit and principle of the present disclosure shall fall within the protection scope of the present disclosure.

What is claimed is:

1. An electrical connector, wherein the electrical connector comprises:
a shell;
an electrical connection portion, wherein the electrical connection portion is arranged on the shell;
an actuator, wherein the actuator is rotatably connected to the shell;
a first gear, wherein the actuator is in transmission connection with the first gear to cause the first gear to rotate;
a shaft lever, wherein the shaft lever is provided with a second gear, a first threaded region, and a second threaded region; the second gear meshes with the first gear; the first threaded region has the same thread direction as the second threaded region, and is in threaded connection with the shell; and the second threaded region is configured to be screwed into a hole of the adapter connector to be fastened with an inner wall of the adapter connector.

2. The electrical connector according to claim 1, wherein the electrical connector is a plug; the adapter connector is a socket; the electrical connection portion comprises a pin; and the pin and the second threaded region can enter the hole of the adapter connector together to electrically connect the pin with the adapter connector.

3. The electrical connector according to claim 2, wherein the electrical connector comprises a plurality of shaft levers; the plurality of shaft levers are parallel to each other; the plurality of shaft levers are distributed in a circumferential direction of the first gear; and one of the shaft levers corresponds to a position of one pin.

4. The electrical connector according to claim 3, wherein when the second threaded region is in a fastened state, the second threaded region is located on a thin surface of the pin.

5. The electrical connector according to claim 1, wherein the second threaded region is a self-tapping cutting thread.

6. The electrical connector according to claim 1, wherein the actuator and the first gear have axially penetrating inner cavities; a cable connected to the electrical connection portion is threaded into the inner cavities and extends out of the shell from an outer end of the actuator; and the actuator and the first gear are rotatable relative to the cable.

7. The electrical connector according to claim 1, wherein the shell has a stop surface; the stop surface is located on a rear side of the second gear; and the stop surface is configured to prevent the second gear from continuing to move backwards.

8. The electrical connector according to claim 1, wherein the shell is provided with a nut; the first threaded region is in threaded connection with the nut; a sliding shaft portion is arranged at a rear end of the shaft lever; the shell is provided with a sliding hole; and the sliding shaft portion is slidably arranged in the sliding hole.
